(19) United States
(12) Patent Application Publication
(10) Pub. No.: US 2012/0042798 A1
(43) Pub. Date: Feb. 23, 2012

(54) REWRITEABLE LITHOGRAPHIC PRINTING SYSTEM

(76) Inventors: Timothy G. Bradley, Longmont, CO (US); Mikel J. Stanich, Longmont, CO (US)

(21) Appl. No.: 12/859,124

(22) Filed: Aug. 18, 2010

(51) Int. Cl. B41F 1/18; B41N 1/00

(52) U.S. Cl. 101/450.1; 101/453

(57) ABSTRACT

Systems and associated methods provide for rewriteable lithographic printing. More specifically, imaging on a printing plate may be erased and the printing plate reimaged for subsequent printing. The printing plate includes a surface coated with a photoswitchable film. An ultraviolet light source is operable to generate an image on the photoswitchable film such that the photoswitchable film is operable to retain the ink on the image for transfer to a tangible medium. A visible light source is then used to erase the image from the photoswitchable film after transfer of the ink to the tangible medium. The photoswitchable film includes a layer of fluorinated azobenzene molecules operable to form the image when exposed to the ultraviolet light and erase the image when exposed to the visible light. The photoswitchable film also includes a bonding layer operable to bond the fluorinated azobenzene molecules to the surface of the lithographic printing plate.

### BACKGROUND

1. Field of the Invention

This invention relates to the field of lithographic printing.

2. Statement of the Problem

Conventional lithographic printing plates are prepared with image-wise hydrophobic/hydrophilic areas. Water is then exposed to the hydrophobic/hydrophilic surfaces of the plate. The water avoids all of the hydrophobic areas, but clings to all of the hydrophilic areas. The surface of the plate is then exposed to an oil-based ink. Since the oil-based ink and the water are immiscible, the oil-based ink avoids the areas that are coated with water and adheres to the remaining areas. In other words, the oil clings to the hydrophobic areas. The oil-based ink and water is then transferred to a blanket cylinder and then onto a tangible medium, such as paper.

Conventional lithographic printing plates are generally prepared outside of printing presses. A plate is first prepared using a dedicated printing plate preparation machine and then installed in a lithographic printing press. This preparation and installation is performed for each image that is to be printed. This problem is compounded in color lithographic printing systems which require a different plate for each color of an image to be prepared and installed. Additionally, newly prepared plates cannot be installed without first removing any plates that are already in the press. The plates being replaced cannot be rewritten and, therefore, represent a significant waste of materials, energy, and time.

Typically, blank lithographic printing plates have a hydrophobic surface which is conditioned to provide hydrophilic regions which are distributed on the surface in an image-wise manner. One example of a lithographic printing plate preparation process involves coating a blank lithographic printing plate with a hydrophobic photopolymer film. This film is exposed to light from a laser. The photopolymer reacts to the light and the light exposed areas of the hydrophobic photopolymer film are removed by exposing the surface to a chemical solvent. This process is wasteful because the hydrophobic photopolymer film is not recoverable and the solvent requires special handling and control. Alternatively, chemistry free plates are produced using a thermal technology which burns an image onto a plate. Again, however, the plate is single use and is used to print a single set of data for one color in the process (e.g., a single signature).

A newer technology has evolved that provides for rewriteable lithographic printing plates that do not require replacement of the plates in the printer. The visible light returns the medium to a superhydrophobic state. The erase can be selective so as to change only portions of the medium back to superhydrophobic state. In this manner, some information can be changed. This new technology involves the use of azobenzene compounds to control the hydrophilic nature of the lithographic printing plate. The azobenzene compounds are placed in a water solution and used to coat a surface of the lithographic printing plate. The azobenzene compounds are then exposed to a laser to remove ions and change hydrophilic properties of the azobenzene compounds (AZO) to a hydrophobic state. The hydrophobic azobenzene compound then rises to the surface of the water solution and combines with and supports an oil-based ink. Thereafter, the ink and the laser modified AZO compound are transferred with the water solution to a lithographic blanket for transfer to a tangible medium. However, the azobenzene compounds that are removed in this manner need to be replenished by providing additional water solution with unmodified azobenzene compounds, resulting in the continual usage of required printing materials.

### SUMMARY

Embodiments herein provide for rewriteable lithographic printing. More specifically, a rewriteable printing plate provides a means for using a single printing plate for a variety of different print jobs, since imaging on the printing plate may be erased and the printing plate reimaged for subsequent printing. The lithographic printing plate includes a surface coated with a photoswitchable film. An ultraviolet light source is operable to generate an image on the photoswitchable film such that the photoswitchable film is operable to retain the ink on the image for transfer to a tangible medium. For example, an ultraviolet laser may be used to controllably “draw” and image the photoswitchable film. A visible light source is then used to erase the image from the photoswitchable film after transfer of the ink to the tangible medium. The photoswitchable film includes a layer of fluorinated azobenzene molecules (e.g., CF3AZO) operable to form the image when exposed to the ultraviolet light and erase the image when exposed to the visible light. The photoswitchable film also includes a bonding layer operable to bond the fluorinated azobenzene molecules to the surface of the lithographic printing plate. The bonding layer may include silica (e.g., silica nanoparticles having a diameter of about 11 nm) combined with a polyelectrolyte (e.g., poly(allylamine hydrochloride)) having a molecular weight of about 70,000.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a rewriteable lithographic printing process in an exemplary embodiment.

FIGS. 2A and 2B illustrate hydrophilic properties of a lithographic printing plate in an exemplary embodiment.

FIGS. 3A and 3B illustrate hydrophobic properties of the lithographic printing plate in an exemplary embodiment.

FIGS. 4A and 4B illustrate materials of a photo switchable film on the lithographic printing plate and its reactions to visible light and ultraviolet light in an exemplary embodiment.

FIG. 5 is a block diagram of a rewriteable lithographic printing system in an exemplary embodiment.

FIG. 6 is another block diagram of a rewriteable lithographic printing system in an exemplary embodiment.

FIG. 7 is another block diagram of a rewriteable lithographic printing system in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below, but by the claims and their equivalents.

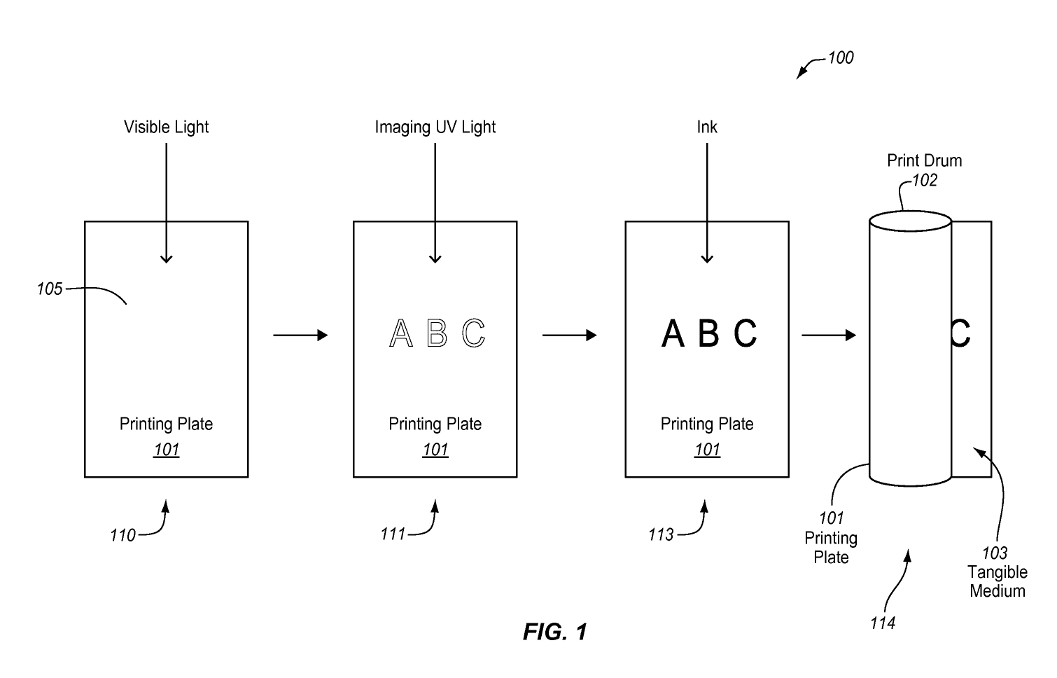

FIG. 1 illustrates a rewriteable lithographic printing process 100 in an exemplary embodiment. To perform the lithographic printing process 100, ink is applied to a lithographic printing plate 101 in an image wise manner such that the ink may be transferred from the printing plate 101 to a tangible medium 103. The printing plate 101 may include any material having a surface capable of transferring the ink to the tangible medium 103. The printing plate 101 may be configured about a print drum 102 such that the printing plate 101 may roll over the tangible medium 103 to apply the ink thereto. The printing plate 101 may be configured within a variety of ink-based printer types, ranging from relatively small desktop printers to high-volume production printers. The printing plate 101 is coated with a photoswitchable film 105 that allows the lithographic printing plate 101 to be rewriteable. That is, the printing plate 101 may be erased and reimaged for subsequent printing. The photoswitchable film 105 thus remains with the printing plate 101 and is capable of undergoing multiple lithographic printing processes 100.

To prepare the printing plate 101 for the lithographic printing process 100, the printing plate 101 is exposed to visible light in the process element 110. The visible light establishes a uniform hydrophobic surface on the printing plate 101 (i.e., via a photoswitchable film 105) such that ink does not adhere to the printing plate 101. The printing plate 101 may then be imaged using ultraviolet light in the process element 111. For example, exposure of the printing plate 101 to ultraviolet light causes the photoswitchable film 105 to become hydrophilic such that ink adheres to the printing plate 101. When performed in an image wise fashion (i.e., the ultraviolet light controllably “draws” onto the printing plate 101), the resulting image on the printing plate 101 becomes hydrophilic while the remaining portions of the printing plate 101 remain hydrophobic. Such is illustrated with the faint letters “ABC” on the printing plate 101 in the process element 111. With the printing plate 101 imaged, ink is then applied to the printing plate 101 in the process element 113. The ink is retained on the imaged portion on the printing plate 101 as illustrated with the darker letters “ABC”. Afterwards, the printing plate 101 transfers the ink image to the tangible medium 103 in the process element 114 via, for example, by way of the print drum 102.

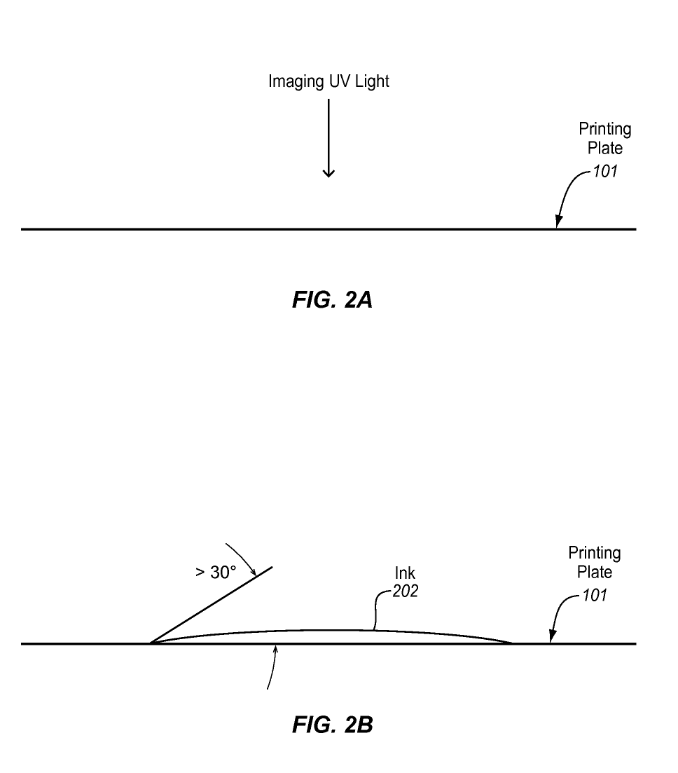

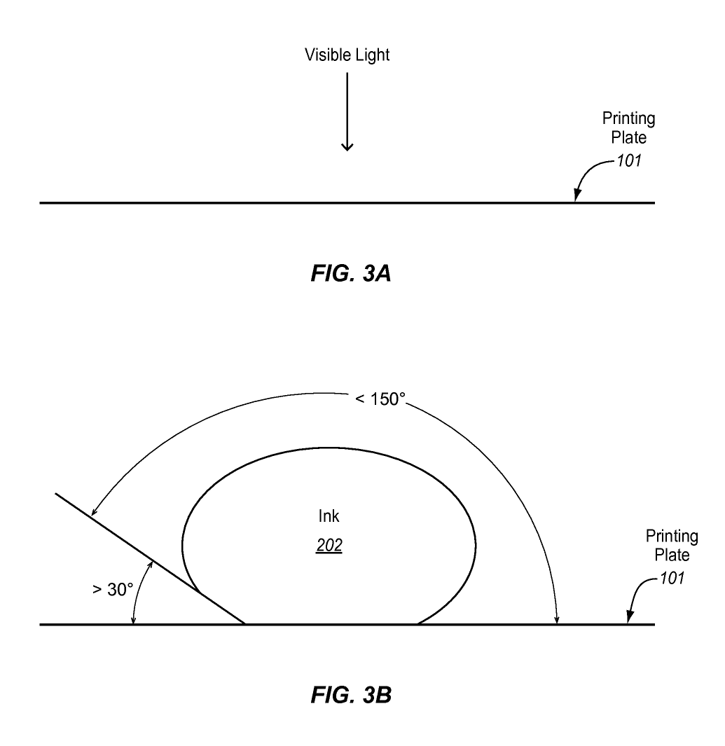

FIGS. 2A and 2B illustrate hydrophilic properties of a lithographic printing plate in an exemplary embodiment. When the printing plate 101 is imaged with ultraviolet light, as illustrated in FIG. 2A, the printing plate 101 becomes hydrophilic. That is, the photoswitchable film coated on the printing plate 101 causes liquid to adhere to the printing plate 101 when exposed to the ultraviolet light. The photoswitchable film on the printing plate 101 is configured from materials that allow the printing plate 101 to become super hydrophilic such that the contact angle of the ink 202 is less than 30° as illustrated in FIG. 2B. FIGS. 3A and 3B, on the other hand, illustrate the hydrophobic properties of the lithographic printing plate 101 when exposed to visible light. For example, when the photoswitchable film on the printing plate 101 is exposed to visible light (FIG. 3A), the materials of the photoswitchable film cause the printing plate 101 to become super hydrophobic causing the ink 202 to “bead” on the surface of the printing plate 101, as is illustrated in FIG. 3B. Generally, the term super hydrophobic refers to a liquid having a contact angle of greater 150°. When the printing plate 101 becomes super hydrophobic, the ink 202 does not adhere to the surface of the printing plate 101 and tends to “roll off” the printing plate 101 or at least portions of the printing plate 101 that are not super hydrophilic (i.e., non imaged portions). The ink or liquid viscosity is selected to facilitate the hydrophobic/hydrophilic response of the printing plate 101. Suitable inks include aqueous based dye or pigment based inks similar to those used in ink jet printers.

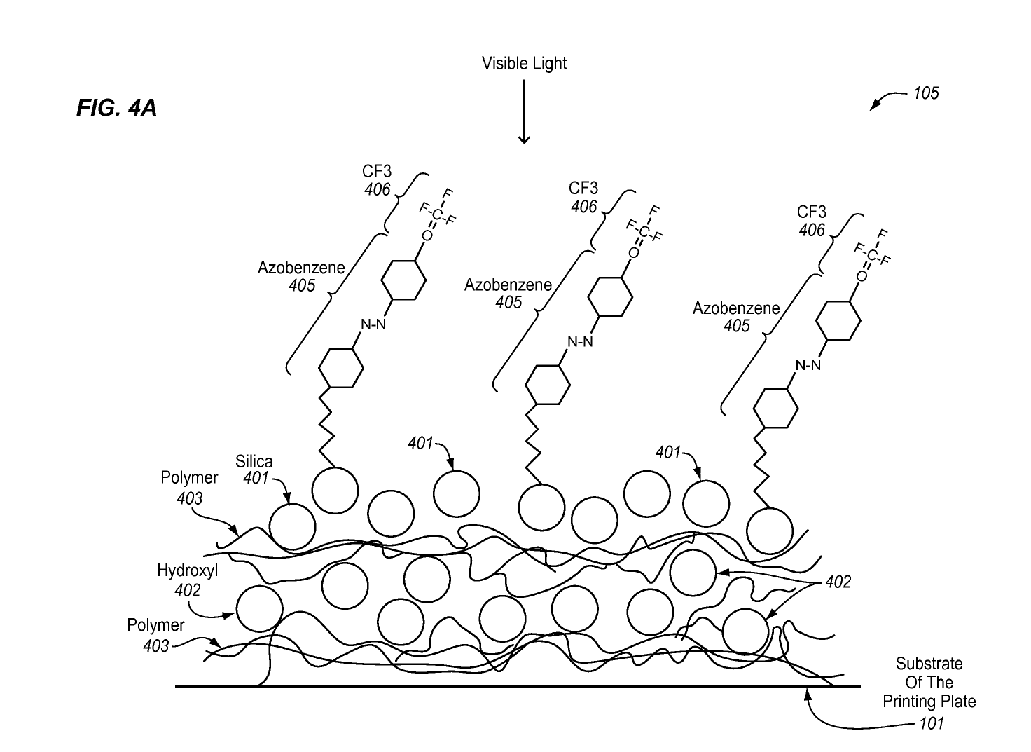

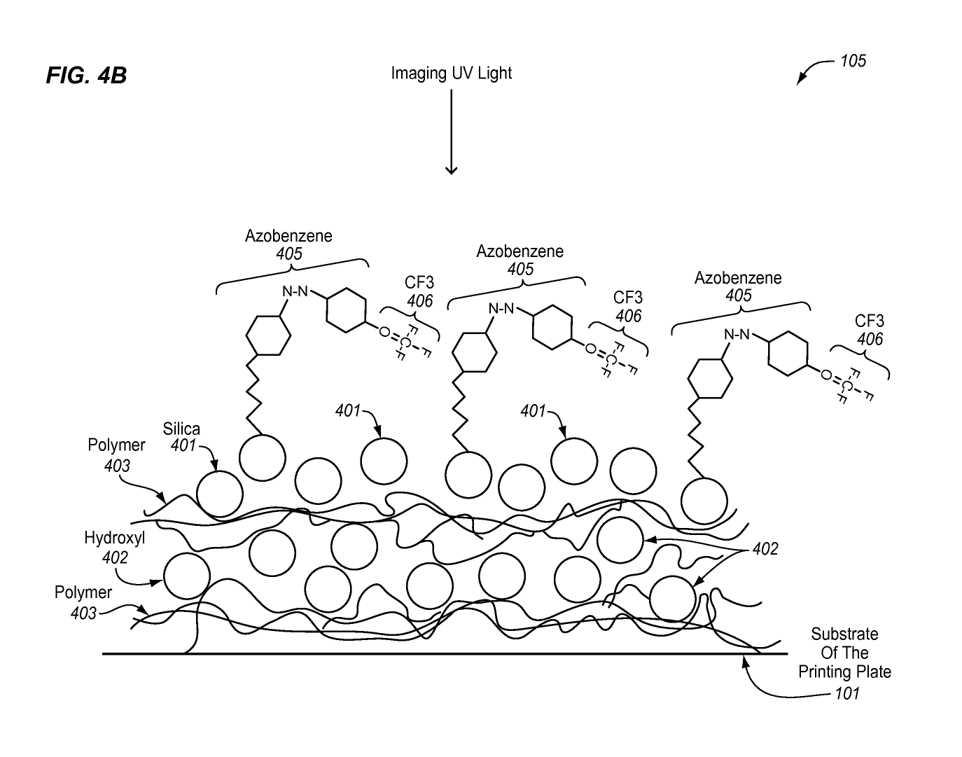

FIGS. 4A and 4B illustrate a photo switchable film 105 on the lithographic printing plate 101 and its reactions to visible light and ultraviolet light in an exemplary embodiment. In this embodiment, the photoswitchable film 105 is configured with fluorinated azobenzene molecules 405/406, or CF3AZO as it is known. These molecules provide the necessary sensitivity to external stimulus for making the photoswitchable film 105 transition between super hydrophobic and super hydrophilic states. Generally, azobenzene and its derivatives are known to exhibit large changes in both geometry and dipole moments as a result of the exposure to ultraviolet and visible light because of reversible photoisomerization between the cis and trans conformations, which means that the “wettability” of an azobenzene-modified printing plate 101 can be altered via the exposure to ultraviolet and visible light. Previously, azobenzene modified surfaces prepared on flat substrates exhibited minor changes in liquid contact angles (e.g., less than 10°) as a result of ultraviolet light illumination. The photoswitchable film 105, however, has a nanoporous multilayer with a wettability that can be reversibly switched between super hydrophobic and super hydrophilic using visible light and ultraviolet light, respectively.

To produce the photoswitchable film 105, facile surface roughness control is combined with an electrostatic self-assembly process and photoresponsive molecular switching of fluorinated azobenzene molecules. This results in a printing plate 101 with erasable and rewriteable patterns. For example, porous organic-inorganic hybrid multilayer films may be configured with hierarchical structures on negatively charged Si wafers. A polyelectrolyte and poly(allylamine hydrochloride) is used to form a polymer hydroxyl (PAH) layer 403/402/403 (e.g., having a molecular weight of about 70,000). Using a “layer-by-layer” technique with SiO2 nanoparticles (i.e., silica 401 having a diameter of about 11 nm), the polycation and polyanion are respectively formed. This provides a bonding layer such that photoswitchable moieties may adhere to the surface of the printing plate 101. In this regard, the photoswitchable moieties remain with the printing plate 101 after ink has been transferred to the tangible medium 103. After deposition, the bonding layer is modified with 3-(aminopropyl)triethoxysilane, which provides binding sites for introducing the photoswitchable moieties. The material is then treated with a photoswitchable agent, 7-[(trifluoromethoxyphenylazo) phenoxy]pentanoic acid (i.e., the fluorinated azobenzene molecules 405/406), which is synthesized. The surface roughness and nanoporosity of the films gradually intensify with increases in the number of PAH/SiO2 bilayers.

The fluorinated azobenzene molecules 405/406 are operable to form an image when exposed to ultraviolet light and erase the image when exposed to the visible light. For example, in FIG. 4A, when the fluorinated is azobenzene molecules 405/406 are exposed to visible light, the molecules 405/406 “stiffen” and make the photoswitchable film 105 super hydrophobic and thus less likely to allow for ink to adhere to the printing plate 101. When the entire printing plate 101 is exposed to visible light, the fluorinated azobenzene molecules 405/406 provide a relatively uniform super hydrophobic state for the printing plate 101. In FIG. 4B, on the other hand, when the fluorinated azobenzene molecules 405/406 are exposed to ultraviolet light, the molecules 405/406 bend and form a super hydrophilic state for the printing plate 101. Thus, if the ultraviolet light is exposed to the printing plate 101 in a controllable fashion (e.g., by way of an ultraviolet laser), the ultraviolet light may be used to image the printing plate 101 such that the ink adheres to those imaged portions of the printing plate 101 for transfer to the tangible medium 103. Additionally, the fine scale of the 405/406 molecules, ultraviolet laser light exposure, and direct contact of the ink with the film facilitates a relatively high resolution capability for this technology.

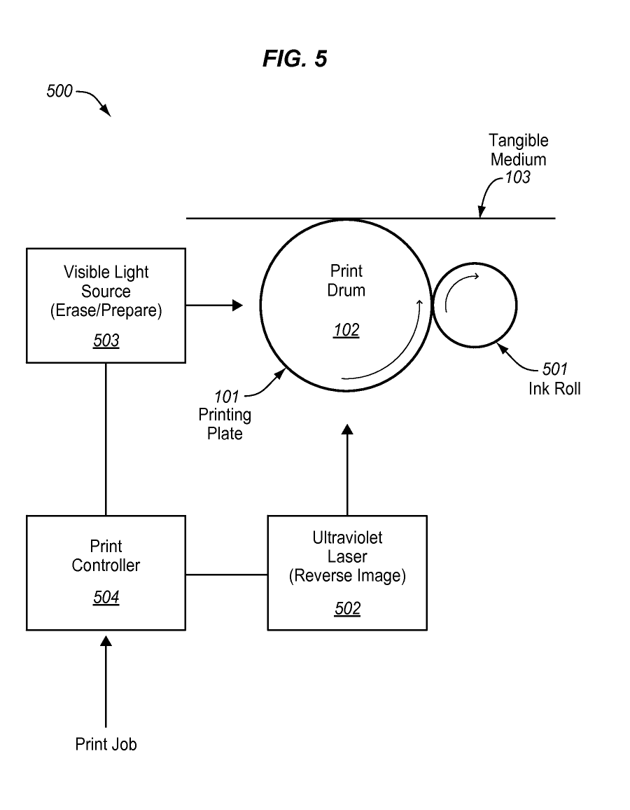

FIG. 5 is a block diagram of a rewriteable lithographic printing system 500 in an exemplary embodiment. The lithographic printing system 500 includes a print controller 504, a visible light source 503, an ultraviolet laser 502, the print drum 102, and an ink roll 501. The printing system 500 may also include other components not shown for the sake of brevity. The print controller 504 may be any device configured from hardware, software, firmware, or any combination thereof operable to receive and process print jobs that include image data (i.e., images and/or text) for presentation to the tangible medium 103. The print drum 102 is configured with the printing plate 101. As discussed above, the printing plate 101 is configured with the photoswitchable film that allows the printing plate 101 to be rewriteable. The visible light source 503 is operable to provide visible light to the print drum 102 so as to erase the printing plate 101 and/or prepare the printing plate 101 for printing. The ultraviolet laser 502 is any type of ultraviolet laser suitable for use in a printing system (e.g., a class 3b ultraviolet laser). The ultraviolet laser 502 may also include various other objects to assist in the imaging of the printing plate 101; such optical configurations are known and not illustrated for the sake of brevity. The ink roll 501 is any device capable of applying ink to a surface, such as that of the printing plate 101.

It should be noted that the ultraviolet/visible light sources of the imaging can be interchanged. For example, ultraviolet light can be used initially to erase and prepare the film surface to render it hydrophilic. Such would be followed by a visible light source selectively rendering the film hydrophobic. In this case, the image exposure is not inverted. Such a system may have advantages as it may use a more readily available visible light source and initial conditioning with UV. In such as system, an array imaging technology may be employed, such as a Light Emitting Diode (LED) array.

The print controller 504 is operable to control the various components of the printing system 500 such that the printing system represents the image data of the print job as ink on the tangible medium 103. For example, the print controller 504 may control the rotation speed of the print drum 102 and expose the printing plate 101 to the visible light from the visible light source 503 to erase/prepare the printing plate 101 for printing. As the print from 102 rotates, the print controller 504 directs the ultraviolet laser 502 to image the erased printing plate 101. The ink roll 501 applies the ink to the printing plate 101 and the ink adheres to the imaged portions of the printing plate 101 due to the super hydrophilic properties of the imaged area. The print drum 102 rotates such that the inked image presses against the tangible medium 103 and transfers thereto.

In this embodiment, the print controller 504 directs the ultraviolet laser 502 to reverse image onto the printing plate 101 such that the image data appears as intended. For example, the transfer of an image from the print drum 102 to the tangible medium 103 is similar to a mirror reflecting an image in reverse. This form of lithographic printing may have significant image quality advantages over ink jet printers because the ink drops are formed are on the surface of the printing plate 101, which ensures that they accurately register. These drops are then directly applied to the tangible medium 103, eliminating the delivery of ink drops through air before impacting the tangible medium 103. This direct application of ink drops provides ink registration accuracy and decreases the possibility of printer artifacts.

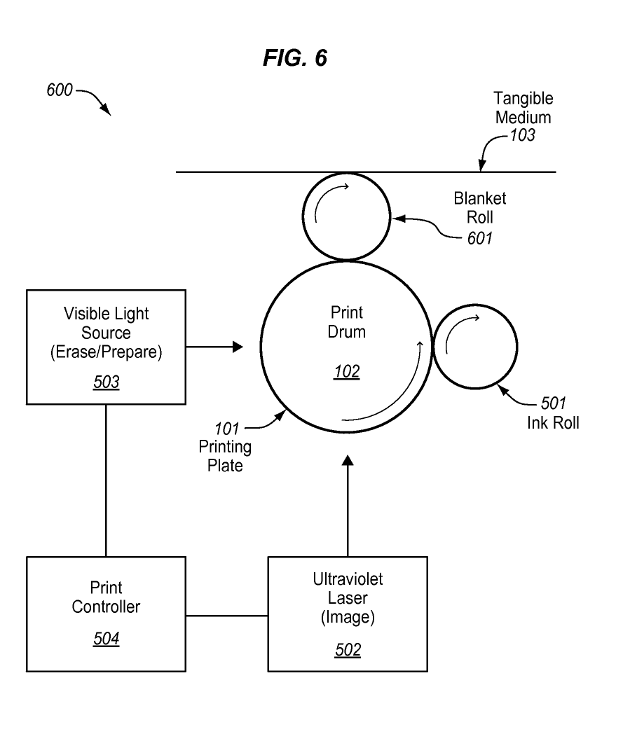

FIG. 6 is a block diagram of another rewriteable lithographic printing system 600 in an exemplary embodiment. In this embodiment, the printing plate 101 is imaged in the forward direction. The ink roll 501 applies ink to the print drum 102, which adheres to the imaged portions of the printing plate 101. The printing plate 101 then transfers the ink image to a blanket roll 601 for transfer to the tangible medium 103.

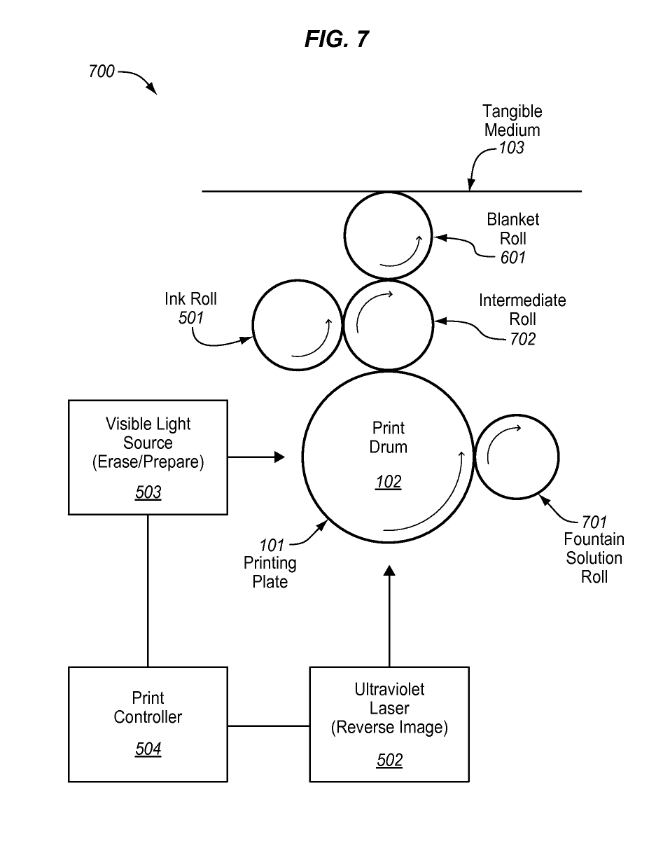

FIG. 7 is a block diagram of another rewriteable lithographic printing system 700 in an exemplary embodiment. In this embodiment, the printing system 700 is configured for digital offset lithographic printing where, instead of an aqueous ink, a fountain solution is used to create a reverse video image which is transferred to an intermediate roll 702. The intermediate roll 702 may then be inked with an organic ink, standard offset ink, or eco friendly soy based ink such that only the non-wetted surface of the intermediate roll 702 is inked to create the desired image. The inked image is then transferred to a blanket roll 601 and onto the tangible medium 103. The printing system 700 may be advantageous as it allows for the use of a relatively rough paper because the blanket roll 601 contacts the paper instead of the printing plate 101.

Although specific embodiments are described herein, the scope of the invention is not limited to the specific embodiments. For example, ink is traditionally referred to as a liquid substance that is used for marking. Such substances exist in various forms, any of which may be implemented with various embodiments of the present invention. Additionally, other types of substances, such as toner, may be implemented with one or more of the described embodiments. In this regard, ink is intended to describe virtually any type of material that is used to mark a tangible medium. Accordingly, the scope of the invention is defined by the following claims and any equivalents thereof.

We claim:

1. A lithographic printing system, comprising:
an ink source;
an ultraviolet light source;
a visible light source; and
a lithographic printing plate operable to transfer ink from the ink source to a tangible medium, the lithographic printing plate comprising a surface coated with a photoswitchable film, wherein the ultraviolet light source is operable to generate an image on the photoswitchable film, wherein the photoswitchable film is operable to retain the ink on the image for transfer to the tangible medium, and wherein the visible light source is operable to erase the image from the photoswitchable film after transfer of the ink to the tangible medium,
wherein the photoswitchable film comprises:
a layer of fluorinated azobenzene molecules operable to form the image when exposed to the ultraviolet light and erase the image when exposed to the visible light; and
a bonding layer operable to bond the fluorinated azobenzene molecules to the surface of the lithographic printing plate.

2. The lithographic printing system of claim 1, wherein the bonding layer comprises silica combined with a polyelectrolyte.

3. The lithographic printing system of claim 2, wherein the polyelectrolyte comprises poly(allylamine hydrochloride).

4. The lithographic printing system of claim 3, wherein the poly(allylamine hydrochloride) comprises a molecular weight of about 70,000.

5. The lithographic printing system of claim 2, wherein the silica comprises silica nanoparticles having a diameter of about 11 nm.

6. The lithographic printing system of claim 1, wherein the ultraviolet light source comprises an ultraviolet laser.

7. The lithographic printing system of claim 1, further comprising a print controller operable to receive and process a print job and control direction of the ultraviolet light based on the print job.

8. The lithographic printing system of claim 1, wherein the print controller is further operable to control timing between the exposure of the ultraviolet light and the exposure of the visible light.

9. The lithographic printing system of claim 1, wherein the fluorinated azobenzene molecules comprise CF3AZO.

10. A method of lithographic printing, comprising:
coating a lithographic printing plate with a photoswitchable film, wherein the photoswitchable film comprises:
a layer of fluorinated azobenzene molecules operable to form an image when exposed to ultraviolet light and erase the image when exposed to visible light, wherein an imaged portion of the layer is operable to retain ink for transfer to a tangible medium; and
a bonding layer operable to bond the fluorinated azobenzene molecules to the surface of the lithographic printing plate;
exposing the photoswitchable film with the visible light to establish a uniform hydrophobic surface;
exposing a portion of the photoswitchable film with the ultraviolet light to generate the image on the photoswitchable film;
applying the ink to the photoswitchable film, wherein the ink is retained on the imaged portion of the photoswitchable film; and
transferring the ink to a tangible medium to print the image.

11. The method of claim 10, further comprising exposing the photoswitchable film with the visible light to erase the image.

12. The method of claim 10, wherein exposing a portion of the photoswitchable film with the ultraviolet light comprises directing an ultraviolet laser to the portion of the photoswitchable film to generate the image on the photoswitchable film.

13. The method of claim 10, wherein the bonding layer comprises silica combined with a polyelectrolyte.

14. The method of claim 13, wherein the polyelectrolyte comprises poly(allylamine hydrochloride).

15. The method of claim 14, wherein the poly(allylamine hydrochloride) comprises a molecular weight of about 70,000.

16. The method of claim 13, wherein the silica comprises silica nanoparticles having a diameter of about 11 nm.

17. The method of claim 10, wherein the fluorinated azobenzene molecules comprise CF3AZO.
